(19) United States
(12) Patent Application Publication
(10) Pub. No.: US 2006/0214871 A1
(43) Pub. Date: Sep. 28, 2006

(54) Additional thin display device for supplementing a primary display

(76) Inventor: Ryuichi Iwamura, San Diego, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/088,393

(22) Filed: Mar. 23, 2005

(51) Int. Cl. G09G 5/00

(52) U.S. Cl. 345/1.1

(57) ABSTRACT

A display system for a computer includes a primary display and a secondary thin display that is selectively activated to supplement the primary display. In some examples, the thin display panel includes an organic electroluminescent display. A method of supplementing a primary display for a computer includes integrating the secondary thin display with the primary display, where the secondary thin display is selectively activated to supplement the primary display.

### BACKGROUND

Portable computers, including laptop, notebook and tablet computers, have become increasingly popular and convenient. A common laptop can now weigh less than three pounds and can be less than an inch thick. This makes it possible to carry and use a portable computer with great ease in almost any environment.

However, with this convenience typically comes a decrease in the size of various components, such as the screen and keyboard of the portable computer. Typically, a user would like a relatively large keyboard and screen. But screen size and keyboard size have both been sacrificed to reduce the overall size of the portable computer. For example, as compared to a desktop computer, the keyboard and screen of a conventional laptop computer are significantly smaller.

In particular, the smaller size of the portable computer screen may make it difficult to view the desired amount of information. While windows and text can be sized as desired by the user, those who may wish to view multiple documents or applications simultaneously may have difficulty fitting the desired material on the relatively small screen area of a portable computer at a size that is convenient to read and edit. These difficulties may be even greater for those with less than perfect eyesight who are trying to work with a relatively small portable computer screen. If the portable computer is being used to display motion picture video or other multimedia or graphic information, the smaller screen may again be a disadvantage.

Some more recent portable computers have reversed the trend of decreasing screen size, offering a larger, particularly wider, screen. These computers are well suited to some applications, but do become bulky, heavier and generally more difficult to transport.

### SUMMARY

A display system for a computer includes a primary display and a secondary thin display that is selectively activated to supplement the primary display. In some examples, the thin display panel includes an organic electroluminescent display. A method of supplementing a primary display for a computer includes integrating the secondary thin display with the primary display, where the secondary thin display is selectively activated to supplement the primary display.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1a illustrates a thin panel display integrated as a secondary display device in the primary display device of a portable computer according to one exemplary embodiment of principles described herein.

FIG. 1b shows a block diagram of a portable computer incorporating both a primary display and a secondary thin display according to one exemplary embodiment of principles described herein.

FIG. 2 is a cross sectional top view of a display housing incorporating a secondary along with the primary display according to one exemplary embodiment of principles described herein.

FIG. 3 illustrates a plurality of secondary thin display devices incorporated into the primary display of a portable computer according to one exemplary embodiment of principles described herein.

FIG. 4 illustrates a plurality of secondary thin display devices incorporated in a desk-top, flat panel display according to one exemplary embodiment of principles described herein.

FIG. 5 illustrates a plurality of secondary thin display device connected to a primary, cathode ray tube (“CRT”) display according to one exemplary embodiment of principles described herein.

FIG. 6 is a flow chart describing a method of activating a secondary thin display device used to augment the primary display of a portable or other computer according to one exemplary embodiment of principles described herein.

FIG. 7 is a flow chart describing an alternative method of activating a secondary thin display device used to augment the primary display of a portable or other computer according to one exemplary embodiment of principles described herein.

FIG. 8 is a flow chart describing another alternative method of activating a secondary thin display device used to augment the primary display of a portable or other computer according to one exemplary embodiment of principles described herein.

FIG. 9 is a flow chart describing an exemplary algorithm for operating a secondary thin display device according to principles described herein.

FIG. 10 is a flow chart describing another exemplary algorithm for operating a secondary thin display device according to principles described herein.

FIG. 11 is a flow chart describing another exemplary algorithm for operating a secondary thin display device according to principles described herein.

Throughout the drawings, identical reference numbers designated similar, but not necessarily identical, elements.

### DETAILED DESCRIPTION

The present specification describes the use of a thin display device to readily extend or augment the available display area of, for example, a portable or other computer, without increasing the size and decreasing the portability of the computer. As described herein, an extendable thin display device can be incorporated into the primary display housing of a portable or other computer or other device. The thin display device is then extended as desired to increase the total available display area.

As used herein and in the appended claims, the term “thin display device” or “thin display panel” will be used to refer to a particular class of display devices that are thinner, lighter and require less power than such conventional display devices as liquid crystal displays (“LCD”). In the future, improved LCDs may be developed that meet the criteria of a thin display device. However, conventional LCDs are not considered “thin display devices” as used herein. Examples of thin display devices include thin-film transistor backplane displays, electrophoretic displays, electro-optic displays, organic electro-luminescent displays and microcapsule displays.

A thin display device may be flexible and paper-like. A thin display device typically does not need backlighting to effectively produce a visible display. Ambient light that is reflected by the display is sufficient to make the displayed image visible to the viewer. Consequently, the thin display device has relatively lower power requirements. In short, thin display devices provide advantages and characteristics that have not been available with any previous display technologies.

In particular, the use of an organic electro-luminescent (OEL) display is disclosed herein as a secondary display device for use with the primary display device of a portable or other computer or other device. An organic electro-luminescent display utilizes organic phosphors rather than inorganic phosphors as contained in displays such as an LCD. Organic phosphors have extremely high quantum efficiencies for florescence and require approximately half the power that a comparable LCD requires.

In some examples, the thin display device is incorporated into or attached to the housing of the primary display device. The thin display panel can be selectively extended and activated to increase the total display area and, in turn, increase the available work space for the user. In some examples, the thin display device slides into and out of a recess in the housing for the primary display device on a portable or laptop computer. An OEL display, in particular, is quite thin and can be housed, when not in use, behind the primary display device without adding a significant amount of weight or thickness to the unit.

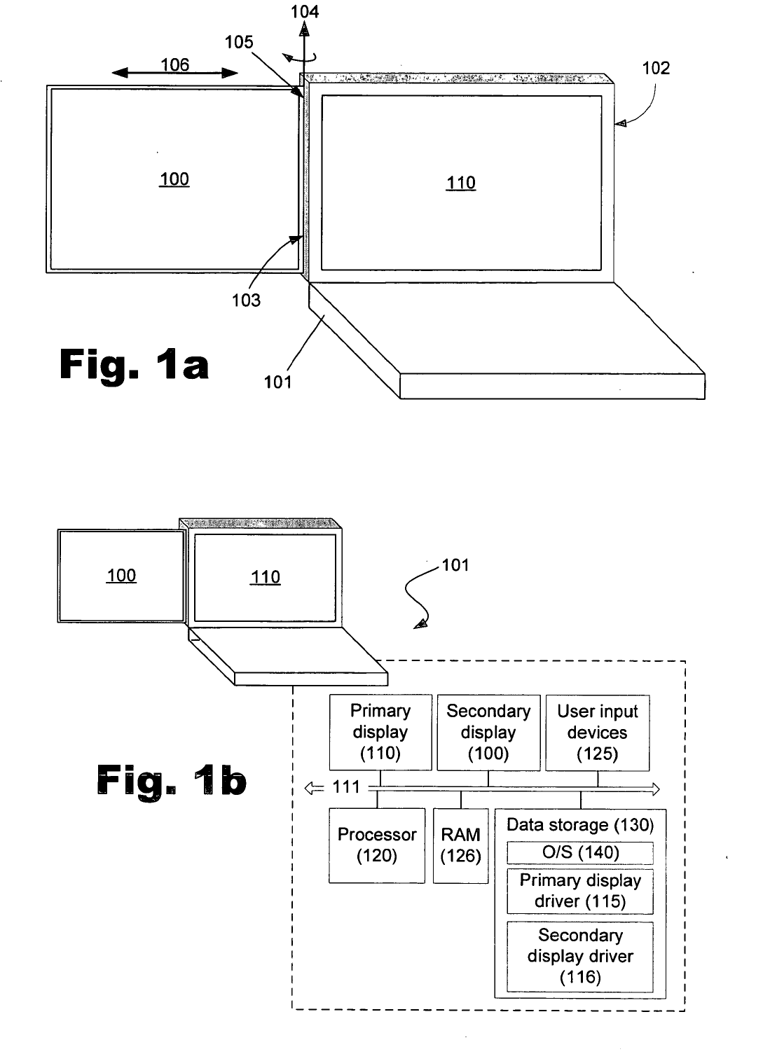

FIG. 1a illustrates a thin display panel (100), for example, an organic electro-luminescent (OEL) display, that functions as a secondary display device to supplement the primary display (110) of a laptop computer (101). As shown in FIG. 1a, the thin display panel (100) resides in a recess (130) in the housing (102) for the primary display device (110). The recess (130) is located behind the primary display (110). Consequently, the secondary thin display (100) can be stored in the recess (130) when not in use and extended from the recess (130) when needed. The thin display panel (100) slides in and out of the recess (103) as indicated by the arrow (106) in FIG. 1a.

As will be discussed in more detail below, the recess (103) may include a switch that is activated when the secondary thin display (100) is extended from the recess (130). This switch provides power to, and activates, the thin display panel (100). The switch may be activated when the thin display panel (100) is partially withdrawn from the recess (103) or may be activated only when the thin display panel (100) is fully extended from the recess (103).

In some examples, the secondary display panel (100) is also pivotally attached to the housing (102). As shown in FIG. 1a, once the secondary display panel (100) is fully extended, it may be pivoted about an axis (104). A hinge (105) connects the secondary display panel (100) to the housing (102) allowing the secondary display panel (100) to pivot about the axis (104). This movement of the secondary display panel (100) allows the secondary display (100) to be positioned by the user at an angle to the primary display (110) that is most convenient for viewing.

With the secondary display panel (100), the user can increase the available display area. This has a number of advantages. For example, the user may wish to open two documents and view both at the same time. Rather than trying to minimize the windows displaying the two documents to fit on the primary display (110), the user can extend the secondary display panel (100) and have a full-size document window displayed on each of the primary (110) and secondary (100) displays. Having two documents displayed simultaneously makes it easier, for instance, for the user to view and compare two the documents side by side, copy and paste more effectively between the two documents, or edit one document while referring to the other. Windows or displays for any two or more applications may be shown on the primary (110) and secondary (100) displays.

The operating system used on the computer (101) will preferably be configured to optionally handle the secondary display panel (100) when deployed. For example, Microsoft® Windows™ is configured to support two separate display devices and will treat the devices as though they are a single seamless display. Thus, the user of the computer shown in FIG. 1a could move a mouse cursor to select items on either the primary (110) or secondary (100) displays as though the two were a single, large display device.

FIG. 1b shows a block diagram of the principal internal components of a portable computer system incorporating both the primary display (110) and the secondary, thin display panel (100) described above. As shown in FIG. 1b, the portable computer includes a central processor (120), a memory unit (126), a data storage device (130), user input devices (125) and display devices (100, 110). The various components of the system are interconnected by a bus (111).

The data storage device (130) may be or include a hard drive. As will be appreciated by those skilled in the art, software stored on the data storage device (130) can be loaded into Random Access Memory (RAM) (126) and executed by the processor (120). Multiple applications can be running simultaneously.

User input devices (125) are operated by the user to control the computer, launch or terminate applications, and provide input to the various applications running on the system. The user input devices (125) may include, for example, a keyboard, a mouse, a trackpad or trackball, microphone, touch-sensitive panel or any other device that can be manipulated by a user to provide input to the computer (101)

As indicated, the data storage device (130) is typically a hard drive, but may also be or include an optical disk, floppy disk, memory card, keychain drive, or any other device for storing data for use by the processor (120). As shown in FIG. 1b, the software stored on the data storage device (130) includes an operating system (O/S) (140) for the computer (101).

When running on the computer (101), the operating system software (140) will launch a primary display driver (115) with which the operating system (140) controls the primary display device (110). Additionally, when the secondary display panel (100) is activated, the operating system (140) will launch a secondary display driver (116) with which the secondary display (100) is controlled. Consequently, data generated by the operating system or applications also running on the computer (101) can be displayed on either of the primary (110) and secondary (100) displays.

As mentioned above, the operating system software (140) may be able to support multiple display devices. Consequently, the operating system (140) treats the primary (110) and secondary (100) displays like a single unit. The transition between displays is seamless. For example, if the user moves a cursor or drags an item from the primary display (110) to the secondary display (100), the operating system treats this action in the same way as if the user has merely moved the cursor or item across a single display unit, for example, the cursor or dragged item will disappear at the edge of the primary display (110) and reappear on the secondary display panel (100).

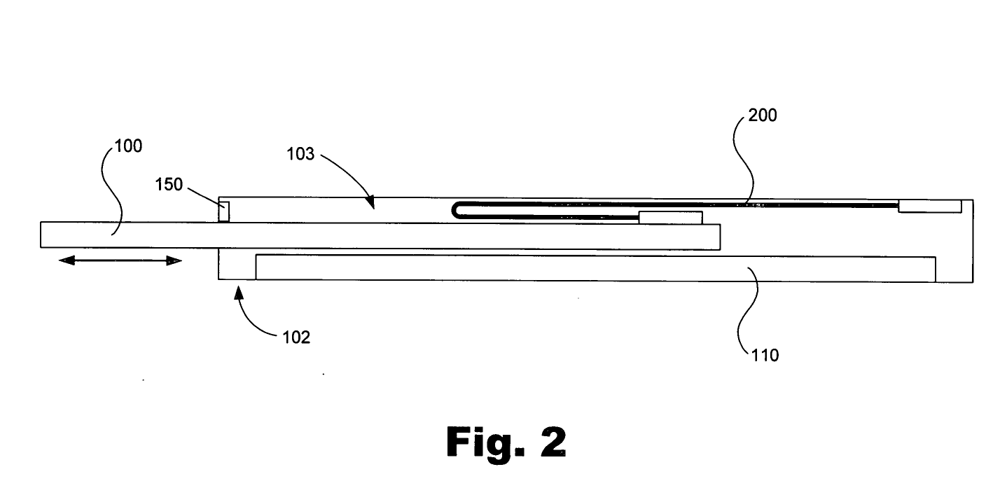

FIG. 2 is a cross sectional top view of the display housing (102) illustrated and described above in connection with FIG. 1a. Many portable computers utilize an LCD as the primary display. Due to the thinness of both an LCD display and the secondary thin display described herein, for example, an organic electro-luminescent (OEL) display, there is easily sufficient space in the housing (102) to support both displays without requiring the display housing to be significantly thicker than on a conventional, single display laptop.

As shown in FIG. 2, and described above, the OEL secondary display (100) is extendable and retractable with respect to a recess (103) in the housing (102). According to one exemplary embodiment, the OEL secondary display (100) is pulled out from behind the primary display (110) at the left of the primary display (110). However, in other possible examples, the OEL or other secondary thin display (100) may be extended from behind the primary display (110) at the right or above the top of the primary display (110). These possibilities will be described in greater detail below.

The secondary thin display (100) is connected to the electronics of the portable computer via a cable (200). The cable (200) can be any cable that transfers video data to the secondary thin display (100). In one example, the cable (200) is a flexible, flat cable. Such a flexible cable can readily fold over itself as the secondary thin display (100) is extended from, and retracted into, the recess (103). This is shown in FIG. 2.

As described above, the secondary thin display (100) can be automatically activated with a switch (150) in the housing (102) that is actuated by extending the secondary display panel (100). The switch (150) may be activated when the secondary thin display (100) is partially extended a predetermined distance or may only be activated when the secondary thin display (100) is fully extended. The switch (150), when actuated, will provide power to the secondary thin display (100) and signal the operating system (140, FIG. 1) that the secondary display is active. The operating system (140, FIG. 1) will then begin driving the secondary thin display (100), for example, as if it were an integral part of the primary display (110). Retracting the secondary thin display (100) back into the recess (103) may again actuate the switch (150) so as to deactivate the secondary thin display (100).

In another example, the secondary thin display (100) may be activated when the user pushes a button or key sequence, or selects an on-screen item, designated to activate the secondary thin display (100). As before, when the user activates the secondary display, power is provided to the secondary thin display (100) and the computer begins to utilize the display with an appropriate driver. The display (100) may then be deactivated with the user action.

In the preceding examples, it is presumed that the user will manually extend and retract the secondary thin display (100). However, in other examples, a motor or mechanical driver may be provided for extending and retracting the secondary thin display (100). In such an example, user input, such as pressing a designated button or key sequence or selecting an on-screen item, can be entered with the user input devices (125, FIG. 1) to initiate extension or retraction of the secondary thin display (100). The same user action can also server to automatically activate or deactivate the secondary thin display (100).

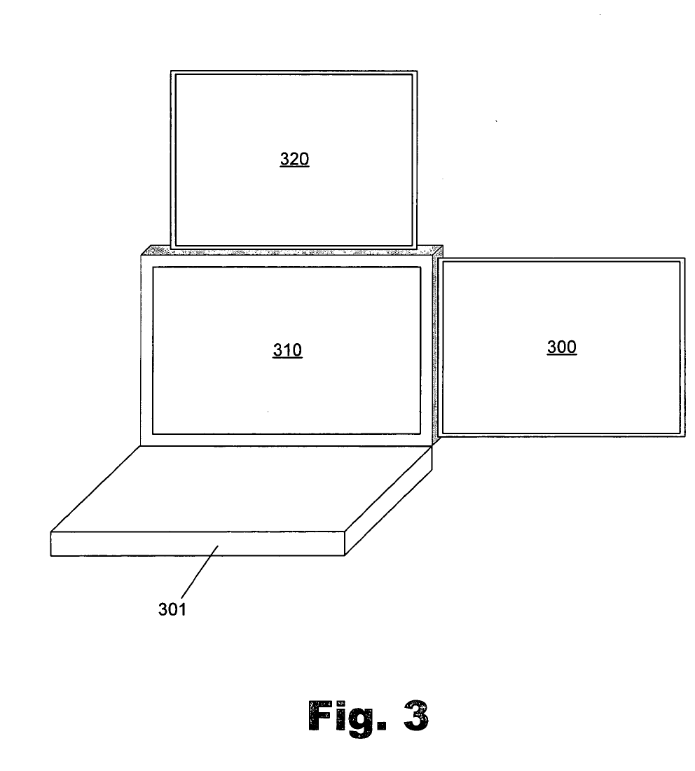

FIG. 3 illustrates a plurality of secondary thin displays (300, 320), for example OEL displays, integrated with a primary display (310) of a portable computer (301). In FIG. 3, the secondary displays (300, 320) extend from the right and top of the primary display (310). However, in other examples, secondary displays can extend from any or all of the left, right and top of the primary display (310).

Similar to the structure in FIG. 2, the first secondary display (300) and second secondary display (320) are connected to the electronics of the portable computer (301) via cables (e.g., FIG. 2, 200), for example, flexible flat video cables. Appropriate display drivers are provided in the memory unit of the computer (301) for any and all additional displays included with the primary display (310). Switches may be incorporated into the recesses that house the secondary displays (300, 320) so as to automatically activate the displays (300, 320) when extended. Alternatively, the secondary displays (300, 320) may be activated by a button, key sequence or other user input entered on the portable computer (301). The secondary displays (300, 320) may be manually extended and retracted, or motorized for automated movement into and out the display housing.

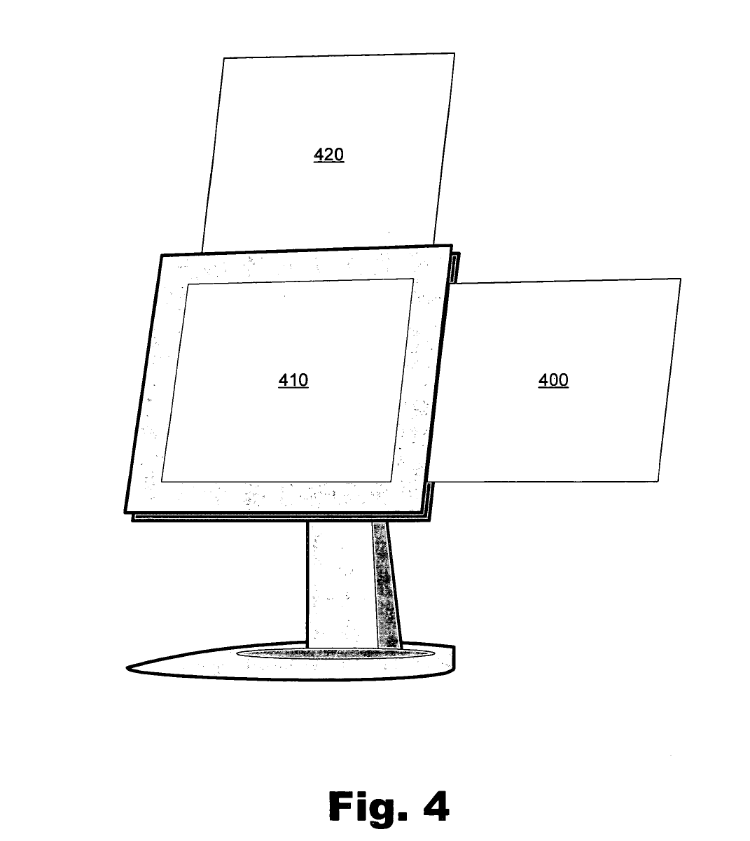

FIG. 4 illustrates a plurality of secondary displays (400, 420), for example OEL displays, that are integrated into a desk-top flat panel display unit (410). These secondary displays (400, 420) can function in the same manner as described above. In FIG. 4, the secondary displays (400, 420) extend from the right and top of the primary display (410). However, in other examples, secondary displays can extend from any or all of the left, right and top of the primary display (410).

Similar to the structure in FIG. 2, the first secondary display (400) and second secondary display (420) are connected to the electronics of the flat panel display (410) via cables (e.g., FIG. 2, 200), for example, flexible flat video cables. Appropriate display drivers are provided in the memory unit of a computer using the flat panel display (410) for any and all additional displays included with the primary display (410).

As before, switches may be incorporated into the recesses that house the secondary displays (400, 420) so as to automatically activate the displays (400, 420) when extended. Alternatively, the secondary displays (400, 420) may be activated by a button, key sequence or other user input entered on the computer connected to the flat panel display (410). The secondary displays (400, 420) may be manually extended and retracted, or motorized for automated movement into and out the display housing.

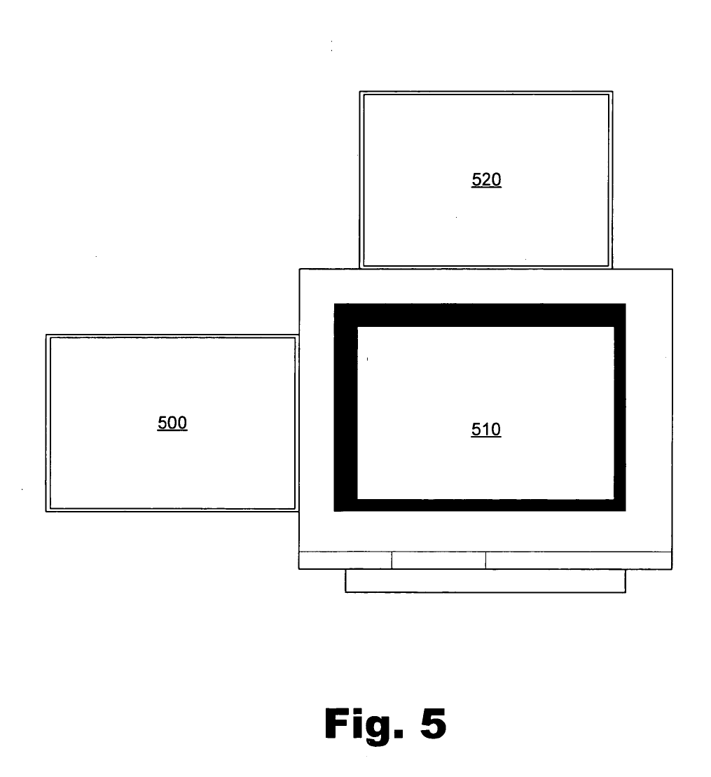

FIG. 5 illustrates a plurality of secondary displays (500, 520), for example OEL displays, that are integrated with a cathode ray tube (CRT) display (510). Unlike a laptop display (110) or a flat panel display (410), these secondary displays (500, 520) do not enter and reside in the housing of the CRT display (510). The structure of the cathode ray tube would impede such disposal of the secondary displays (500, 520).

Consequently, in one example, the secondary displays (500, 520) are hinged to the CRT display (510). The secondary displays (500, 520) can pivot so as to lay flat against the top or side of the CRT display (510) when not in use. When needed, one or more secondary displays (500, 520) can be pivoted from a storage position to a viewable position as shown in FIG. 5.

Switches may be employed that are automatically actuated to activate a particular secondary display (500, 520) when that display is moved into a viewable position, i.e., away from the side or top of the CRT display (510). Alternatively, the secondary displays (500, 520) may be activated by a button, key sequence or other user input entered on the computer connected to the CRT display (510). The secondary displays (500, 520) may be manually extended to a viewable position, as shown in FIG. 5, or may be motorized for automated movement into a viewable position.

The first secondary display (500) and second secondary display (520) may be connected to the electronics of the CRT display (510) via cables (e.g., FIG. 2, 200). Additionally, appropriate display drivers are provided in the memory unit of a computer using the CRT display (510) for any and all additional displays included with the primary CRT display (510).

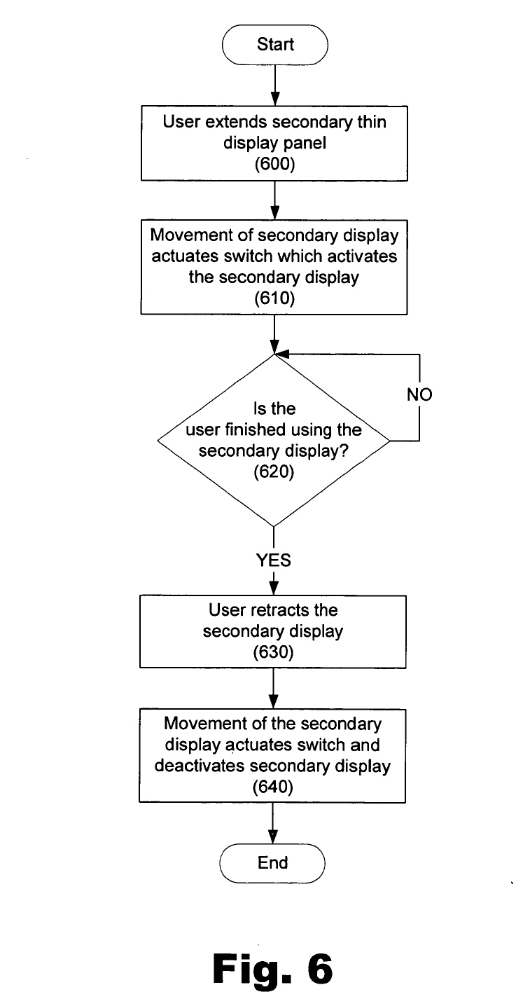

FIG. 6 is a flow chart describing a method of activation of a thin display panel, such as an OEL display, that is used as a secondary display for a portable or other computer system. First, the user extends the secondary display (step 600). As described above, the secondary display may be extended from a storage position in a recess located behind the primary display to a viewable position. Alternatively, the secondary display may be pivoted into a viewable position from a folded storage position against a side of a CRT display. Several types of mechanical elements may be incorporated in this step to allow the user to more easily extend and retract the secondary display.

As the user extends the secondary display, a switch is actuated by the movement of the secondary display panel, as described above. Actuation of the switch activates the secondary display (step 610). As discussed earlier, the switch may be actuated at any point during the extending of the secondary display or may not be actuated until the display is fully extended.

The secondary display is then active for use by the corresponding computer system. Until the user has finished with the secondary display (determination 620), the secondary display remains active and in use.

If the user has finished working with the secondary display (determination 620), the user retracts the secondary display to the storage position (step 630). This may be done by re-inserting the secondary display into a recess in the display housing or folding the secondary display against the side of a primary CRT display. As the secondary display is retracted, the switch is again actuated or opened (step 640). This results in the deactivation of the secondary display (step 640).

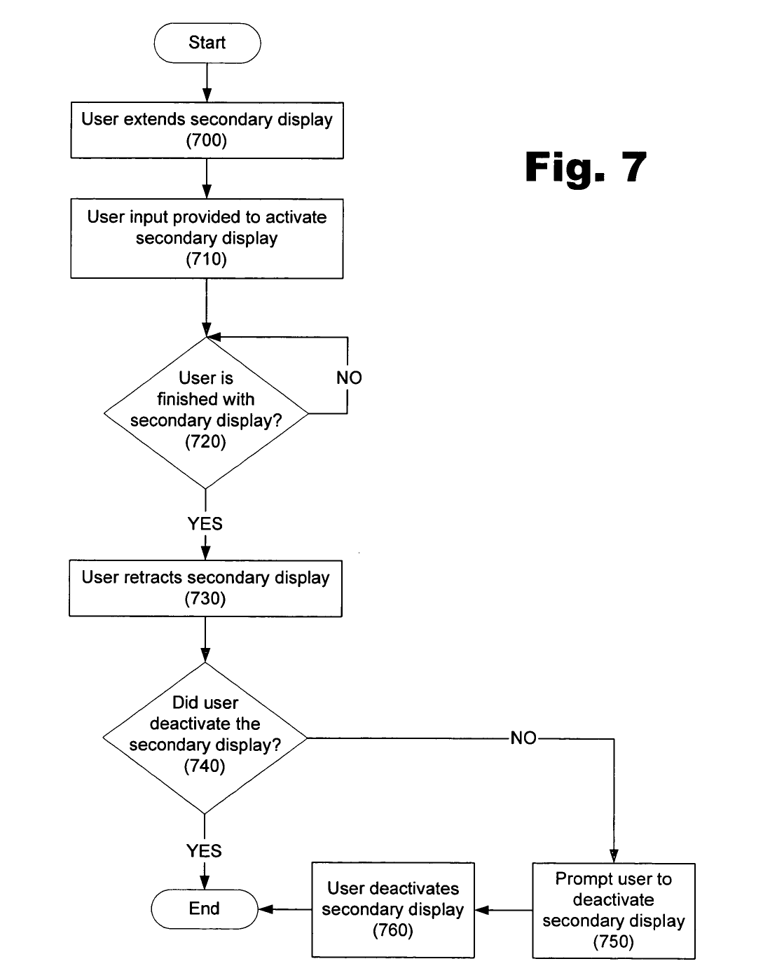

FIG. 7 is a flow chart describing an alternative method of activating a secondary display, for example an OEL display, for a portable or other computer system. As before, the user extends the secondary display (step 700). As described above, the secondary display may be extended from a recess located behind the primary display. Alternatively, the secondary display may be pivoted into a viewable position from a folded storage position against a side of a CRT display. Several types of mechanical elements may be incorporated in this step to allow the user to more easily extend and retract the secondary display.

Next, user input is given to activate the secondary display (step 7 10). This user input may be, for example, the pressing of a dedicated button or entering a key sequence to a keyboard or other user input on the computer system. In some examples, the computer system may prompt the user to extend the secondary display and/or activate the secondary display.

Next, it is determined whether the user is finished working with the secondary display (determination 720). If the user is not finished working with the secondary display, the secondary display remain active.

If the user is finished working with the secondary display (determination 720), then the user retracts the secondary display (step 730). In connection with retracting the display, the user will likely want to also deactivate the display to converse power. Thus, it may be determined whether the user remembered to deactivate the secondary display (determination 740). If the user did deactivate the secondary display, for example, by pressing a dedicated button or entering a key sequence, then the method is finished.

However, if the user did not remember to deactivate the secondary display, then the computer system may prompt the user to deactivate the secondary display (step 750). This prompting may occur in response to there being no activity on the secondary display for a predetermined period of time. For example, the user does not activate a window, select an icon, move a cursor on, or take other action within the secondary display for a predetermined period of time. The prompting to deactivate the secondary display may be displayed on the primary display.

Upon being prompted, the user then deactivates the secondary display (step 760), as described above, by, for example, pressing a dedicated button or entering a key sequence or selecting an option on the primary display, etc. In a portable computer that relies on battery power, the deactivation of the secondary display may be important to conserve the battery and extend the time the portable computer can operate without recharging. Deactivating the secondary display when not in use may also extend the life of the secondary display.

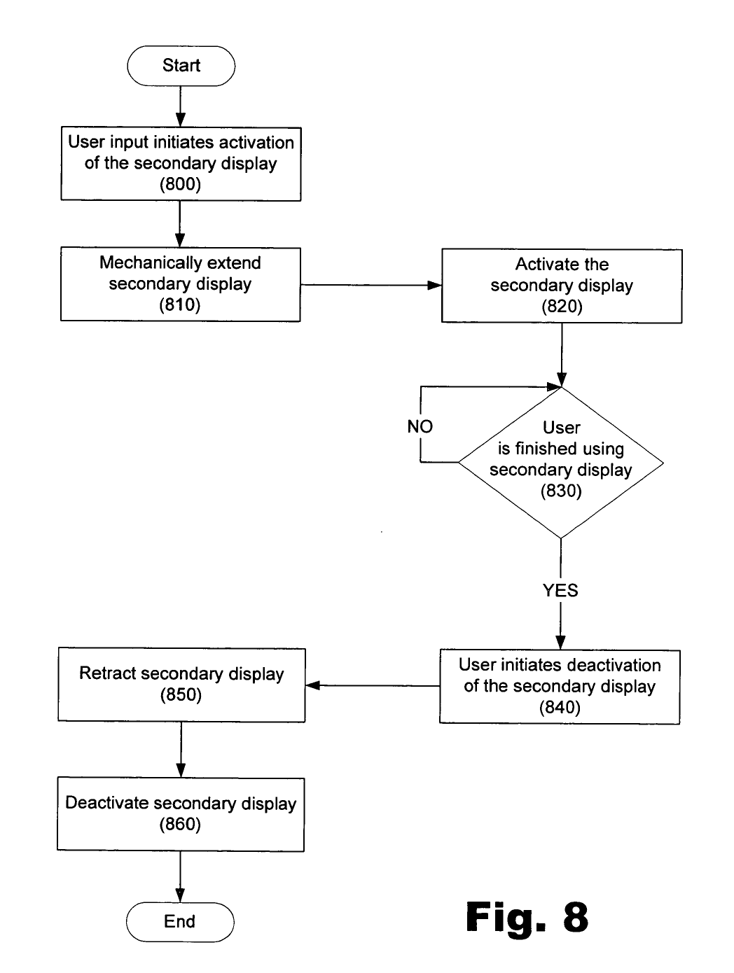

FIG. 8 is a flow chart describing another exemplary method of activating a secondary display, for example an OEL display, for a portable computer or other computer system. First, the user initiates activation of the secondary display (step 800). This may be done by pressing a dedicated button, selecting an item or icon on the primary display, entering a key sequence with a keyboard or any other means of signaling that the user desired activation of the secondary display.

The secondary display is then mechanically extended (step 810). As described above the secondary display may be extended from a recessing a display housing or may be pivoted into a viewable position from a folded or retracted position. Several types of mechanical elements may be incorporated in this step to allow the system to extend and retract the secondary display.

In connection with the extension of the secondary display, the secondary display will be activated by the electronics of the supporting computer system (step 820). This may occur at some point during the extension of the secondary display or when the secondary display is fully extended.

When the user is finished using the secondary display (determination 830), the user initiated deactivation and retraction of the secondary display (step 840). Again, this may be done by any form of user input that can indicate the user's desire to deactivate and retract the secondary display, e.g., pressing a dedicated button, selecting an on-screen option, entering a key sequence, etc. The secondary display is then mechanically retracted (step 850). At some point in the retraction process, the secondary display is also deactivated by the electronics of the supporting computer system (step 860).

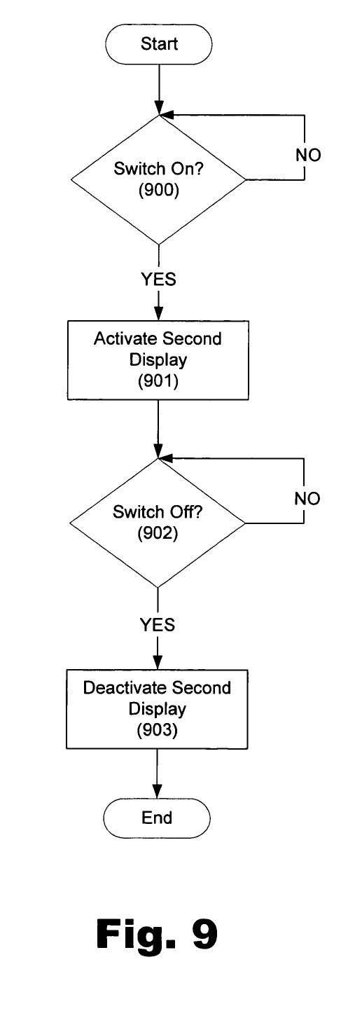

FIGS. 9-11 illustrate a set of algorithms that can be executed by, for example, the processor (120, FIG. 1b) to operate a secondary thin display according to principles described herein. As shown in FIG. 9, the display is automatically activated and deactivated by the switch, described above, that is actuated when the thin display is extended or retracted. With reference to FIG. 9, it is first determined if the switch has been actuated to activate the thin display, e.g., has the thin display been extended, (determination 900). If the switch has been actuated, the secondary thin display is activated (step 901).

The method then waits for the switch to be actuated again (determination 902) by, for example, retraction of the thin display. If the switch is again actuated, the thin display is deactivated (step 903).

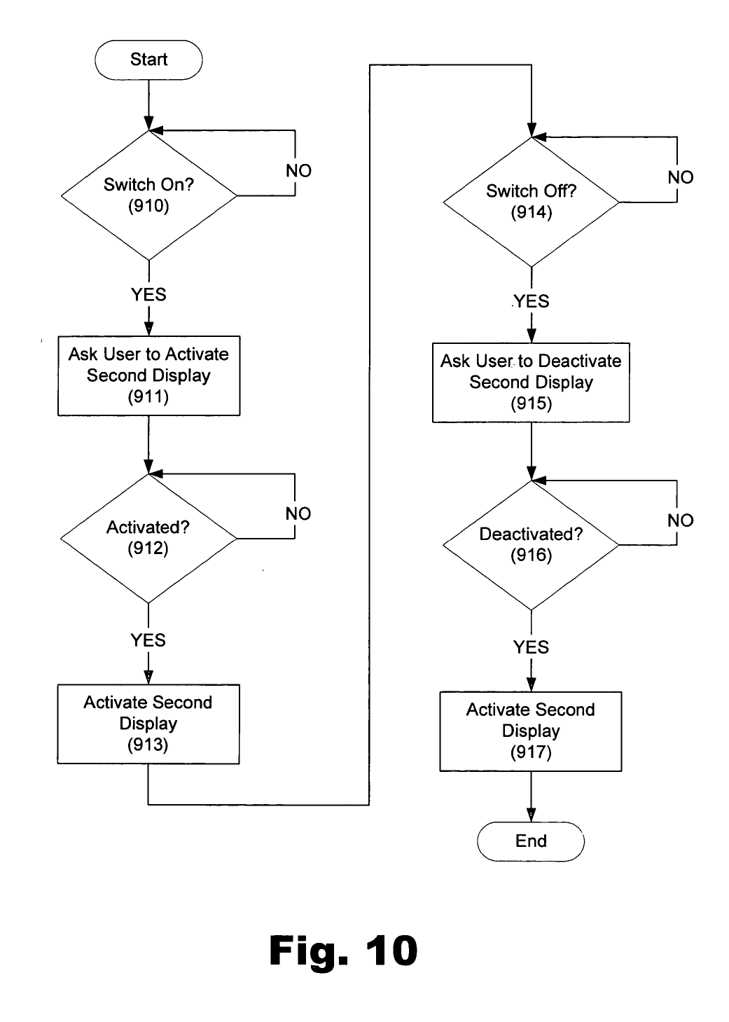

In FIG. 10, the function of the switch is not to activate and deactivate the secondary thin display device, but to cause the system to prompt the user to activate the thin display device. As shown in FIG. 10, when the switch is actuated due, for example, to extension of the thin display device (determination 910), the user is prompted to activate the secondary display (step 911). The user may then choose to activate the secondary display or not (determination 912).

If the user does activate the display (step 913), the user can do so by any of the means described herein, for example, a dedicated button, a key sequence or selecting an on-screen item. The method then waits until the switch is again activated (determination 914) indicating, for example, that the secondary thin display has been retracted. The user is then prompted to deactivate the secondary thin display (step 915).

If the user chooses to deactivate the secondary display (determination 916), the secondary display is deactivated (step 917). Alternatively, the user may have retracted the secondary display only temporarily and may intend to extend and continue using it shortly. In such a case, the user may decline to deactivate the secondary display (determination 916), in which case the secondary display is not deactivated even though it has been retracted.

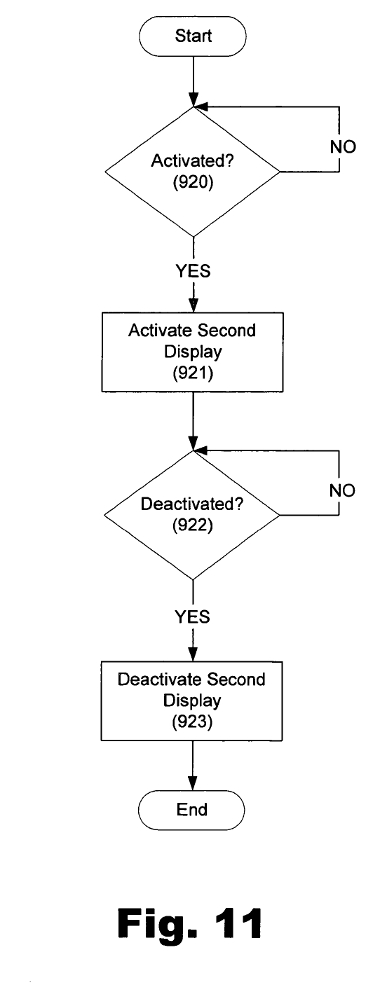

In FIG. 11, the system does not detect the position of the secondary thin display device, i.e., the system is unaware of whether the secondary thin display has been extended or retracted. The switch described above is not used. Rather, the activation and deactivation of the secondary thin display depends entirely on the user.

As shown in FIG. 11, if the user enters a command to activate the secondary thin display (determination 920), then the secondary thin display is activated (step 921). As discussed herein, the user input to activate the secondary thin display may be any type of user input including activating a dedicated button, entering a key sequence, selecting an on-screen item, etc. Similarly, when the user then enters a command to deactivate the secondary thin display (determination 922), the secondary thin display is deactivated (step 923).

The preceding description has been presented only to illustrate and describe embodiments of the invention. It is not intended to be exhaustive or to limit the invention to any precise form disclosed. Many modifications and variations are possible in light of the above teaching.

What is claimed is:

1. A display system for a computer comprising:
a primary display; and
a secondary thin display that is selectively activated to supplement said primary display.

2. The display system of claim 1, wherein said secondary thin display is an organic electroluminescent display.

3. The display system of claim 1, wherein said secondary thin display slides in and out of a recess in a housing for said primary display.

4. The display system of claim 3, wherein said secondary thin display pivots, when extended, with respect to said primary display.

5. The display system of claim 3, further comprising a switch in said recess for automatically activating said secondary thin display when said secondary thin display is extended from said recess.

6. The display system of claim 3, further comprising a drive mechanism for extending said thin display panel from said recess and retracting said thin display panel into said recess.

7. The display system of claim 1, further comprising a plurality of secondary thin display devices that can be selectively activated to supplement said primary display.

8. The display system of claim 1, wherein said primary display is a desk-top flat panel display.

9. The display system of claim 1, wherein said primary display is a portable computer screen.

10. The display system of claim, 1, wherein said primary display is a cathode ray tube display.

11. A portable computer comprising:
a primary display; and
a secondary thin display that is selectively activated to supplement said primary display.

12. The computer of claim 11, wherein said secondary thin display is an organic electroluminescent display.

13. The computer of claim 11, wherein said secondary thin display slides in and out of a recess in a housing for said primary display.

14. The computer of claim 13, wherein said secondary thin display pivots, when extended, with respect to said primary display.

15. The computer of claim 13, further comprising a switch in said recess for automatically activating said secondary thin display when said secondary thin display is extended from said recess.

16. The computer of claim 13, further comprising a drive mechanism for extending said thin display panel from said recess and retracting said thin display panel into said recess.

17. The computer of claim 11, further comprising a plurality of secondary thin display devices that can be selectively activated to supplement said primary display.

18. A display system for a computer comprising:
a primary display; and
a secondary organic electroluminescent display, integrated with said primary display, that is selectively deployed and activated to supplement said primary display.

19. The display system of claim 18, wherein said secondary display slides in and out of a recess in a housing for said primary display.

20. The display system of claim 19, wherein said secondary display pivots, when extended, with respect to said primary display.

21. The display system of claim 19, further comprising a switch in said recess for automatically activating said secondary display when said secondary display is extended from said recess.

22. The display system of claim 18, further comprising a plurality of secondary organic electroluminescent displays that can be selectively deployed and activated to supplement said primary display.

23. A method of supplementing a primary display for a computer comprising integrating a secondary thin display with said primary display, wherein said secondary thin display is selectively activated to supplement said primary display.

24. The method of claim 23, wherein said secondary thin display is an organic electroluminescent display.

25. The method of claim 23, further comprising slidably housing said secondary thin display slides in a recess in a housing for said primary display, wherein said secondary thin display is extended from said recess for use.

26. The method of claim 25, further comprising pivoting said secondary thin display, when extended, with respect to said primary display.

27. The method of claim 25, further comprising activating said secondary thin display with a switch in said recess, said switch being actuated by movement of said secondary thin display with respect to said recess.

28. The method of claim 27, further comprising deactivating said secondary thin display by further actuation of said switch resulting from movement of said secondary thin display into said recess.

29. The method of claim 23, further comprising a selectively deploying any of a plurality of secondary thin display devices that are integrated with said primary display and can be selectively activated to supplement said primary display.

30. The method of claim 23, further comprising selectively activating said secondary thin display in response to user input on said computer.

31. The method of claim 30, further comprising prompting a user to deactivate said secondary thin display.

32. The method of claim 31, further comprising prompting said user to deactivate said secondary thin display based on a lack of activity on said secondary thin display for a predetermined period of time.

33. The method of claim 23, further comprising mechanically extending and retracting said secondary thin display.

34. A system for supplementing a primary display for a computer comprising:
a secondary thin display integrated with said primary display;
means for selectively deploying said secondary thin display from a storage position to a viewable position; and
means for selectively activating said secondary thin display to supplement said primary display.

35. The system of claim 34, further comprising means for driving said primary display and said secondary thin display as if a single display device.
